(19) United States
(12) Patent Application Publication
(10) Pub. No.: US 2024/0326055 A1
(43) Pub. Date: Oct. 3, 2024

(54) SYSTEMS AND METHODS FOR HANDLING AND ANALYZING SAMPLES

(71) Applicant: DH Technologies Development Pte. Ltd., Singapore (SG)

(72) Inventors: Thomas R. COVEY, Newmarket (CA); Chang LIU, Richmond Hill (CA)

(21) Appl. No.: 18/579,231

(22) PCT Filed: Jul. 14, 2022
(86) PCT No.: PCT/IB2022/056513

§ 371 Date: Jan. 19, 2023

Related U.S. Application Data
(60) Provisional application No. 63/222,236, filed on Jul. 15, 2021.
(60) Provisional application No. 63/255,666, filed on Oct. 14, 2021.

(51) Int. Cl. B01L 3/00; H01J 49/04

(52) U.S. Cl. CPC B01L 3/502784; H01J 49/0431; B01L 2200/027; B01L 2300/0829; B01L 2400/0436

(57) ABSTRACT

Methods and systems for handling and/or analyzing samples are provided. In one example, a method comprises: introducing (406), with a liquid handler (322), at least one assisting agent into a sample well (310) of a well plate (312), wherein the sample comprises a sample volume; and ejecting (408), with an acoustic droplet ejector, ADE, (306), a mixture comprising the sample mixed with the at least one assisting agent from the sample well, wherein the at least one assisting agent interacts (406) with an analyte of the sample to limit gel formation at a top surface of the sample volume, prior to the mixture ejection.

### CROSS REFERENCE TO RELATED APPLICATION(S)

This application is being filed on Jul. 14, 2022, as a PCT International Patent Application that claims priority to and the benefit of U.S. Provisional Application No. 63/222,236, filed on Jul. 15, 2021, and U.S. Provisional Application No. 63/255,666, filed on Oct. 14, 2021, which both applications are incorporated by reference herein in their entireties.

### INTRODUCTION

Some assays include the co-existence of a protein and a reducing reagent (e.g. Dithiothreitol (DTT), tris (2-carboxyethyl) phosphine (TCEP), etc.) in the sample solution prior to delivery to an analytical instrument. The presence of the reducing agent is required to disrupt disulfide bonds in the proteins to permit protein analysis of single subunits or to reduce/destroy the protein activity to quench the reaction.

High throughput mass spectrometry, such as by acoustic droplet ejection (ADE) from a sample well, permits fast sample introduction and analysis by ejecting one or more repeatable and controllable sample droplets from each sample well into an open port interface (OPI) for analysis by a mass spectrometer (MS) (i.e. ADE-OPI-MS) after dilution and delivery to the MS. ADE is also used for controlled and measured liquid transfer from one sample well plate to another, prior to quantitative or qualitative analysis. It would be useful to be able to accurately and repeatably eject sample from sample volumes that contain a protein and a reducing agent.

### SUMMARY

In some aspects, the present disclosure relates to a system for analyzing a sample. In one example, the system comprises: a first plate handler: a liquid handler: an acoustic droplet ejector (ADE): an open port interface (OPI): a mass capture and analysis system: a processor operatively coupled to each of the first plate handler, the liquid handler, the ADE, the OPI, and the mass capture and analysis system; and memory, operatively connected to the processor, the memory storing instructions that, when executed by the processor, perform a set of operations comprising: receiving, by the first plate handler, a well plate comprising a plurality of sample wells, each sample well configured to contain a sample having a sample volume: introducing, by the liquid handler, at least one assisting agent into at least one sample well: ejecting, with the ADE, a mixture comprising the sample and the at least one assisting agent from the at least one sample well and into the OPI for transport to the mass capture and analysis system: and detecting, with the mass capture and analysis system, at least one analyte of the mixture.

In some embodiments, the system further comprises a sample handler, wherein the set of operations further comprises introducing, with the sample handler, the sample into the at least one sample well.

In some embodiments, the set of operations further comprises introducing, with the liquid handler, the at least one assisting agent into the at least one sample well, at least one of: before introduction of the sample to the at least one sample well, after introduction of the sample to the at least one sample well, and simultaneously with introduction of the sample to the at least one sample well.

In some embodiments, the mixture is transported from the OPI to the mass capture and analysis system via a transfer conduit.

In some embodiments, the set of operations further comprises introducing a transport liquid to the OPI, and wherein the mixture is diluted in the transport liquid during transport of the mixture to the mass capture and analysis system.

In some embodiments, the system further comprises a housing at least partially enclosing the well plate.

In some embodiments, the system further comprises a non-reactive gas source communicatively coupled to an interior of the housing, and wherein the set of operations further comprises: introducing a non-reactive gas from the non-reactive gas source to the interior of the housing.

In some embodiments, the system further comprises a second plate handler operative to locate an opposed sample well to capture the ejected mixture.

In some embodiments, the system further comprises a protector for selectively applying and removing a seal from the well plate.

In some embodiments, the liquid handler comprises at least one of an automatic pipetting robot, an automated dispensing device, and an acoustic dispenser.

In some aspects, the present disclosure relates to a method for handling a sample for analysis. In one example, the method comprises: introducing, with a liquid handler, at least one assisting agent into a sample well of a well plate, wherein the sample comprises a sample volume: and ejecting, with an acoustic droplet ejector (ADE), a mixture comprising the sample mixed with the at least one assisting agent from the sample well, wherein the at least one assisting agent interacts with an analyte of the sample to limit gel formation at a top surface of the sample volume, prior to the mixture ejection.

In some embodiments, the method further comprises introducing the sample into the sample well.

In some embodiments, the at least one assisting agent prevents gel formation at the top surface of the sample volume, prior to the mixture ejection.

In some embodiments, the method further comprises: supplying a non-reactive gas to isolate the sample well from reactive gas in ambient air; and ejecting the mixture from the sample well through the non-reactive gas.

In some embodiments, the at least one assisting agent is selected from the group consisting of: a reducing agent, an alkylation agent, a blocking agent, a buffer, an enzyme, a substrate, a co-factor, a stabilizer, a viscosity-modifying agent, and combinations thereof.

In some embodiments, the analyte comprises at least one biomolecule analyte having at least a S—S or a S—H group. In some embodiments, the biomolecule analyte is a protein, a peptide, or a molecule having one or more amino acid moieties.

In some embodiments, the at least one assisting agent is capable of stabilizing the biomolecule analyte, or reducing activity of the biomolecule analyte in the sample.

In some embodiments, the at least one assisting agent comprises a reducing agent capable of converting the S—S group into S—H group and/or preventing the S—H group from being oxidized or being coupled to another S—H group.

In some embodiments, the at least one assisting agent further comprises an alkylation agent capable of converting the S—H group into a more stable S—R group.

In some embodiments, the at least one assisting agent reduces inter-molecular coupling of the analyte through S—S formation.

In some embodiments, the reducing agent is selected from the group consisting of: dithiothreitol (DTT), dithioerythritol (DTE), tris (2-carboxyethyl) phosphine hydrochloride (TCEP), 2-mercaptoethanol, 2-mercaptoethylamine, thioglycolic acid, cysteine, guanidine, urea, or any salt or derivative thereof, and combinations thereof.

In some embodiments, the alkylation agent is selected from the group consisting of: iodoacetamide, iodoacetic acid, acrylamide, chloroacetamide, and combinations thereof.

In some aspects, the present disclosure provides a system and method for transferring sample from a sample volume. An alkylation reagent may be introduced into a sample volume containing a protein and a reducing agent. Sample from the resulting sample volume containing the protein, the reducing agent, and the alkylation reagent may be ejected, for instance by acoustic droplet ejection (ADE).

In some aspects, the ejected sample may be captured in an open port interface for dilution and transfer to an ion source for ionization of the diluted sample and subsequent analysis by a mass spectrometer.

In some aspects, the ejected sample may be captured in an opposing sample well for subsequent storage, processing, and/or analysis.

In an embodiment, a system and method is provided for transferring sample from a sample volume containing a protein and a reducing agent. A non-reactive gas, such as nitrogen, may be supplied to isolate the sample volume from reactive gas in ambient air. Sample from the resulting sample volume containing the protein and the reducing agent after the reduction reaction may be ejected, for instance by acoustic droplet ejection (ADE) through the non-reactive gas.

In some aspects, the ejected sample may be captured in an open port interface for dilution and transfer to an ion source for ionization of the diluted sample and subsequent analysis by a mass spectrometer, wherein the non-reactive gas further isolates a capture region of the OPI form the reactive gas of ambient air.

In some embodiments a system is provided, including: a plate handler operative to receive a microtiter well plate: a liquid handler operative to introduce a reducing agent into at least one sample well of the well plate to perform a reduction reaction in the at least one sample well and to introduce an alkylation reagent into the at least one sample well to perform an alkylation reaction in the at least one sample well, and, an acoustic droplet ejector (ADE) operative to eject sample from the at least one sample well after the alkylation reaction has been completed.

The system may further include: an open port interface (OPI) situated to receive and capture sample ejected from the well in a capture region of the OPI and operative to dilute the captured sample and transfer diluted sample to an ion source for ionization of the diluted sample.

The system may further include: a second plate handler operative to locate an opposed sample well to receive the ejected sample.

The system may further include: a mass spectrometer coupled to the ion source and operative to receive the ionized sample and to perform mass analysis on the ionized sample.

The liquid handler may be further operative to introduce a protein sample into the at least one sample well to react with the reducing agent.

The system may be further operative to introduce the reducing agent into a plurality of the sample wells and to introduce the alkylation reagent into the plurality of sample wells before a polymeric layer forms on a surface of any of the sample wells.

In some embodiments a system is provided, including: a plate handler operative to receive a microtiter well plate: a liquid handler operative to introduce a reducing agent into at least one sample well of the well plate to perform a reduction reaction in the at least one sample well: an acoustic droplet ejector (ADE) operative to eject sample from the at least one sample well: a housing enclosing and isolating the sample wells of the microtiter well plate from ambient air: and, a non-reactive gas source in fluid connection with an interior of the housing to supply non-reactive gas, such as nitrogen, to isolate the sample wells from reactive gas in the ambient air.

The system may further include an open port interface (OPI) situated within the housing to capture ejected sample, dilute the captured sample, and transfer diluted sample to an ionization source for ionization, wherein the ejecting of sample from the sample well to the OPI being through the non-reactive gas isolating the sample well.

In some embodiments, a method is provided for transferring sample. The method may include: introducing a reduction reagent to a sample well to perform a reduction reaction within the sample well: introducing an alkylation reagent into the sample well to perform an alkylation reaction in the at least one sample well, and, ejecting sample from the at least one sample well after the alkylation reaction has been completed.

The method may further include: capturing the ejected sample in a capture region of an open port interface (OPI): diluting the captured sample: and, transferring the diluted sample to an ion source for ionization of the diluted sample.

The method may further include: mass analyzing the ionized sample.

In some aspects, the method may further include introducing a protein sample into the sample well to react with the reducing agent and/or performing the method for a plurality of sample wells of a microtiter well plate, wherein the alkylation reagent is introduced into the plurality of sample wells before a polymeric layer forms on a surface of any of the sample wells.

In some embodiments, a method is provided for transferring sample. The method may include: supplying a non-reactive gas to isolate a sample well from reactive gas in ambient air: introducing a reduction reagent to the sample well to perform a reduction reaction within the sample well: and, ejecting sample from the at least one sample well through the non-reactive gas.

The method may include: capturing the ejected sample in a capture region of an open port interface (OPI); diluting the captured sample; and, transferring the diluted sample to an ion source for ionization of the diluted sample, wherein the non-reactive gas further isolates the capture region of the OPI from reactive gas in the ambient air. After transfer, the method may also include mass analyzing the ionized sample.

In some aspects, the method may include isolating the sample well from reactive gases while introducing a protein sample into the sample well to react with the reducing agent. The protein may be introduced into a sample well containing the reducing agent, or the reducing agent may be added to the sample well containing the protein sample.

In some aspects, the sample well may be located in a microtiter well plate containing a plurality of sample wells (e.g. conventionally 96, 384, or 1536 well microtiter plates). In these aspects, any of the methods above may be performed a plurality of times over some or all of the plurality of sample wells in the well plate. In these cases, the method may be performed to ensure that a polymeric gel layer does form over any of the sample wells before sample has been ejected from that sample well plate. Depending upon requirements, the method may ensure that sample may be ejected from all of the sample wells without a polymeric gel layer forming over any of the sample wells. Optionally, additional sample may be ejected from one or more of the sample wells without a polymeric gel layer forming over any of the sample wells.

In some aspects, the method may be performed by maintaining the non-reactive gas isolating the plurality of sample wells and/or the OPI from reactive gas throughout the sampling.

### BRIEF DESCRIPTION OF THE DRAWINGS

FIG. 1A is a simplified sketch illustrating the issue with adding a reducing agent to a protein in a sample volume.

FIG. 1B is a simplified sketch illustrating a prior art method of adding a filtration step after the addition of the reducing agent.

FIG. 2 is a process flow diagram illustrating a method for ejecting sample.

FIG. 3A illustrates mass spectrometer response to repeated samplings from a sample volume containing a reduced protein after addition of a reducing agent with the ADE device set to eject from an aqueous solution.

FIG. 3B illustrates mass spectrometer response to repeated samplings from a sample volume containing a reduced protein after addition of a reducing agent with the ADE device set to eject from a non-aqueous solution

FIG. 4A illustrates mass spectrometer response to repeated samplings from a sample volume containing a reduced protein after addition of a reducing agent and an alkylation reagent with the ADE device set to eject from an aqueous solution.

FIG. 4B illustrates mass spectrometer response to repeated samplings from a sample volume containing a reduced protein after addition of a reducing agent and an alkylation reagent with the ADE device set to eject from a non-aqueous solution.

FIGS. 5-6 are schematic diagrams illustrating exemplary mass analysis systems.

FIG. 7 depicts a schematic view of an example system combining an acoustic droplet ejection system with a sampling interface and an ion source.

FIG. 8 depicts a general scheme of one example approach adopted by the present methods for handling and analyzing a sample.

FIG. 9 depicts a flow diagram of one example method for handling and/or analyzing a sample.

The details of one or more techniques are set forth in the accompanying drawings and the description below. Other features, objects, and advantages of these techniques will be apparent from the description, drawings, and claims.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the terminology used herein is for the purpose of description and should not be regarded as limiting.

### DETAILED DESCRIPTION

Reliably ejecting sample droplets by ADE from sample volumes that contain a protein and reducing agent can pose a challenge. While the reducing reagent initially causes cleavage of the disulfide bonds in the protein structure, the reduction product thiol groups (—SH groups) may be oxidized by oxygen present in ambient air forming new intra-or inter-molecular disulfide bonds. In practice a top layer of a sample volume containing a protein and a reducing agent exposed to ambient air will react with reactive gas in the air (e.g., oxygen) and form a gel-like layer at the top of the sample volume.

Since ADE requires the sample be exposed to the ambient atmospheric conditions, formation of the potential poly-protein (through the inter-molecular disulfide bond formation) at the surface layer changes the fluid properties of the sampling region (e.g., surface region) of the sample volume. Accordingly, optimization of the required acoustic ejection parameters is challenging with unstable ejection performance. As a result, ADE may no longer perform in a controllable and repeatable manner.

The technologies described herein relate to sample transfer, for example, by ejection of sample droplets from a sample well that contains a protein and a reducing agent. The sample droplets are ultimately delivered to an analytical instrument, such as a mass spectrometer, for analysis. The technologies described herein allow for high-throughput analysis of such samples, notwithstanding the reactions taking place within the wells, which might otherwise lead to a reduction in throughput for the reasons noted above.

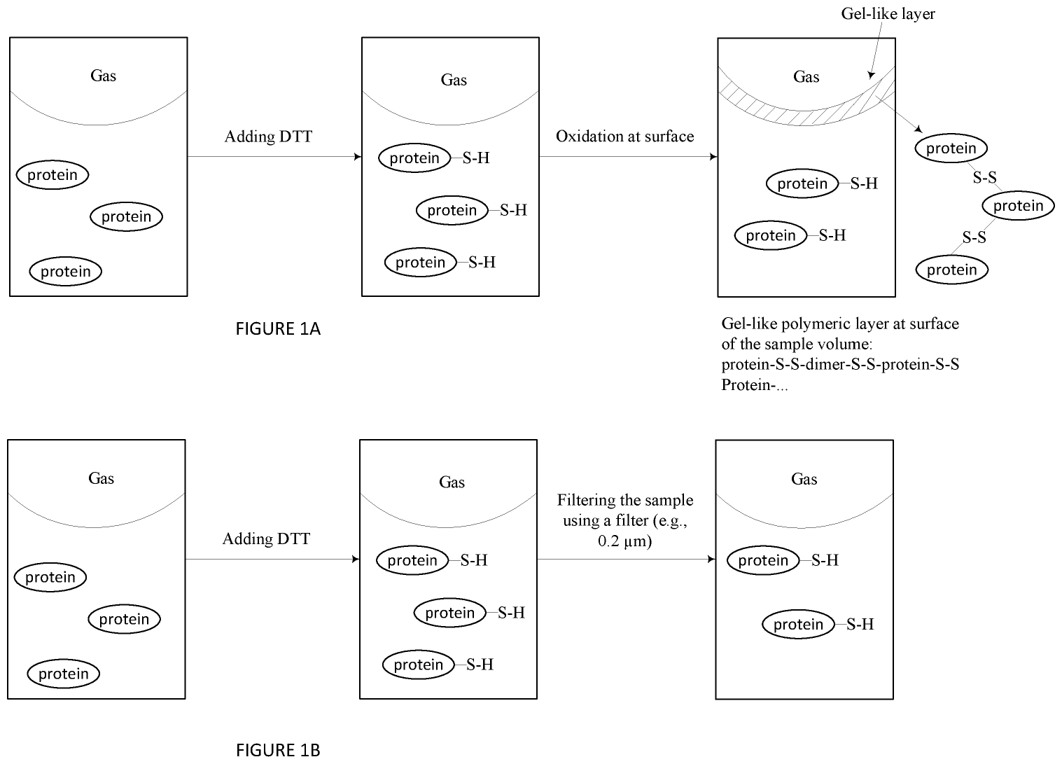

FIG. 1A, illustrates the issue of adding a reducing agent to a protein in sample volume. As indicated, a sample volume may contain a protein as well as protein fragments. In a first step a suitable reducing agent (e.g. DTT, TCEP, etc.) may be added. The reducing agent acting to cleave the protein structure, typically by cleavage of the disulfide bonds in the protein structure, to create a reduced solution of proteins and protein components. If the reduced solution is exposed to air, the reduction product thiol groups (i.e. —SH groups in the example) may react with oxygen present in the air to create a multimeric gel-like layer at the top of the sample volume. The gel layer at the surface of the sample volume having different acoustic properties, i.e. viscosity, from the reduced sample solution.

FIG. 1B illustrates a prior art method of handling this issue by filtering the reduced solution after introducing the reducing agent, for instance with ˜0.2 μm pore size filter, and then eject sample by ADE after completion of the filtration step.

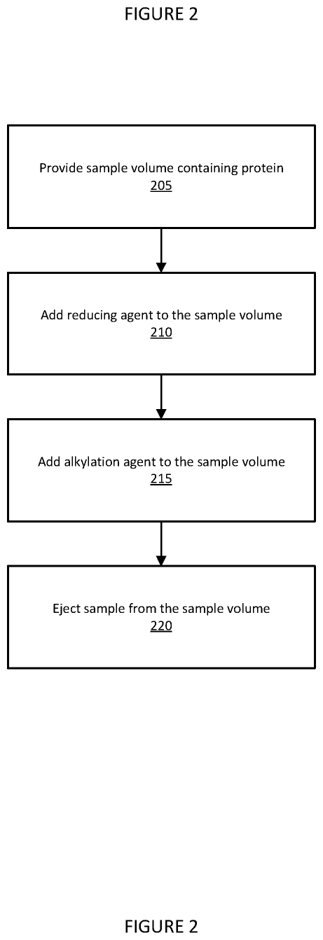

FIG. 2 illustrates a method for ejecting sample. In a first step, a sample containing protein is provided 205. The sample may be prepared in advance, or a protein may be introduced into a sample volume, for instance by a liquid handler.

In a second step a reducing agent is added to the sample volume 210. The reducing agent operative to cleave bonds in the protein to create a reduced protein product.

In a third step an alkylation reagent may be added to the sample volume 215. The alkylation reagent operative to react with the reduced protein products to block any potential polymerization reaction when the sample volume is exposed to air for a period of time.

As an example, the reducing agent may comprise DTT and the alkylation reagent (e.g. iodoacetamide) is added to the sample to react with the thiol groups resulting from the reduction reaction and block a polymerization reaction.

After addition of the alkylation reagent and subsequent alkylation reaction, the sample may be ejected from the sample volume by ADE 220.

The addition of the alkylation reagent is automation friendly-the reagent addition could be achieved, for instance, with a multi-head pipetting system (e.g. 96-head, 384-head, etc.) delivering alkylation reagent to a plurality of wells in a multi-well sample plate. In some embodiments, conveniently all wells in a well plate may be processed simultaneously. Alternatively wells within the well plate may selectively receive alkylation wells, either individually or subgroups of wells within the well plate.

Depending upon the alkylation reaction, specific reaction conditions may be incorporated into the process. For instance, photosensitive reactions may be supported by applying an opaque plate seal, locating the plate in an appropriate incubator, or otherwise isolating the plate from any light source.

### Example 1

In an example, a sample well is provided with phosphate buffered saline (PBS). A protein, Bovine Serum Albumin (BSA) is added at a concentration of 0.1 mg/mL. The protein is reduced by the addition of 1 mM DTT. Sample is then repeatedly ejected from the sample volume using ADE for analysis by mass spectrometry (ADE-OPI-MS). The system used for the example is the commercial SCIEX Echo® MS system first set in aqueous (AQ) mode using acoustic parameters to eject sample from an aqueous sample volume, with the trial repeated in CP mode to eject sample from a non-aqueous sample (e.g. acetonitrile, methanol, ethanol up to 50% in aqueous solution). The AQ mode being optimized for ejecting sample from aqueous sample volumes while the CP mode being intended to cover a broader range of sample types than the AQ mode, which may include being operative to eject sample from both aqueous and non-aqueous sample volumes. Details of the operation of the SCIEX Echo® MS system and its different acoustic modes are publicly available, including in “Direct Analysis from Phase-Separated Liquid Samples using ADE-OPI-MS: Applicability to High-Throughput Screening for Inhibitors of Diacylglycerol Acyltransferase 2”, Anal. Chem. 2021, 93, 15, 6071-6079, and the applicable system manual and technical notes published by SCIEX, both of which are incorporated herein by reference.

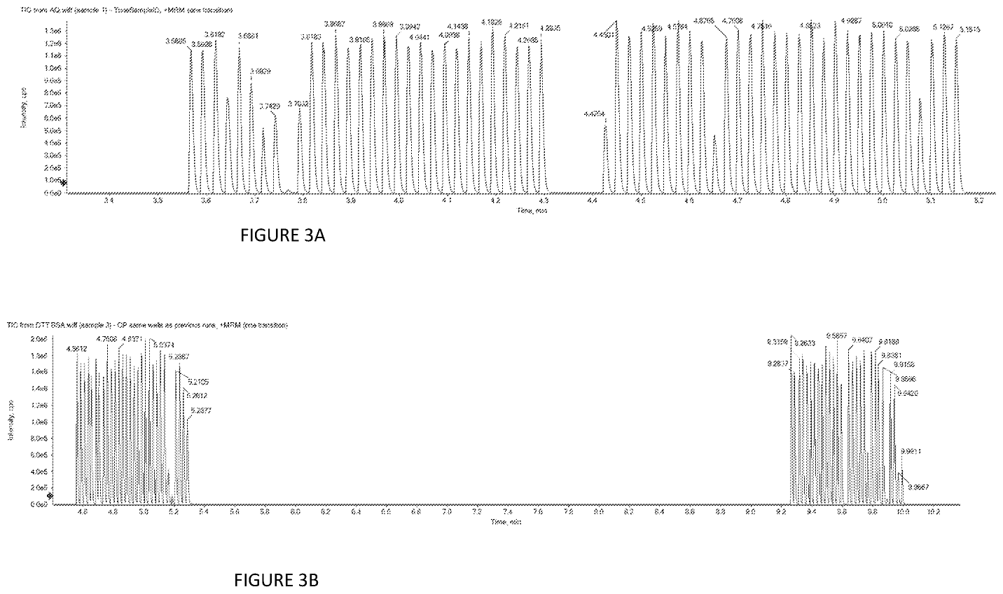

FIG. 3A illustrates the resulting intensity peaks vs. time produced by the mass spectrometer over the sampling period with the ADE (Echo® MS) set in AQ mode. FIG. 3B illustrates the resulting intensity peaks vs. time produced by the mass spectrometer over the sampling period with the ADE (Echo® MS) set in CP mode.

As illustrated in FIGS. 3A and 3B each ejection event results in a separate sampling event from a same sampling well that should, theoretically, be constant and relatively consistent across the sampling period. While the same sample well is being sampled, however, as a result of the oxidation reaction the peaks vary across the sampling period both when the ADE is set to eject from an aqueous solution and when the ADE is set to eject from a non-aqueous solution. The measurement result is varying with time due to the ongoing reaction between the reduced protein components and oxygen in the air, with the physical properties of the sample volume continually changing over the sampling period. As a result the ADE is unable to deliver repeatable and controlled sample droplets from the sample volume. This observation has rendered ADE-OPI-MS to be considered ineffective for sampling these reduced protein samples.

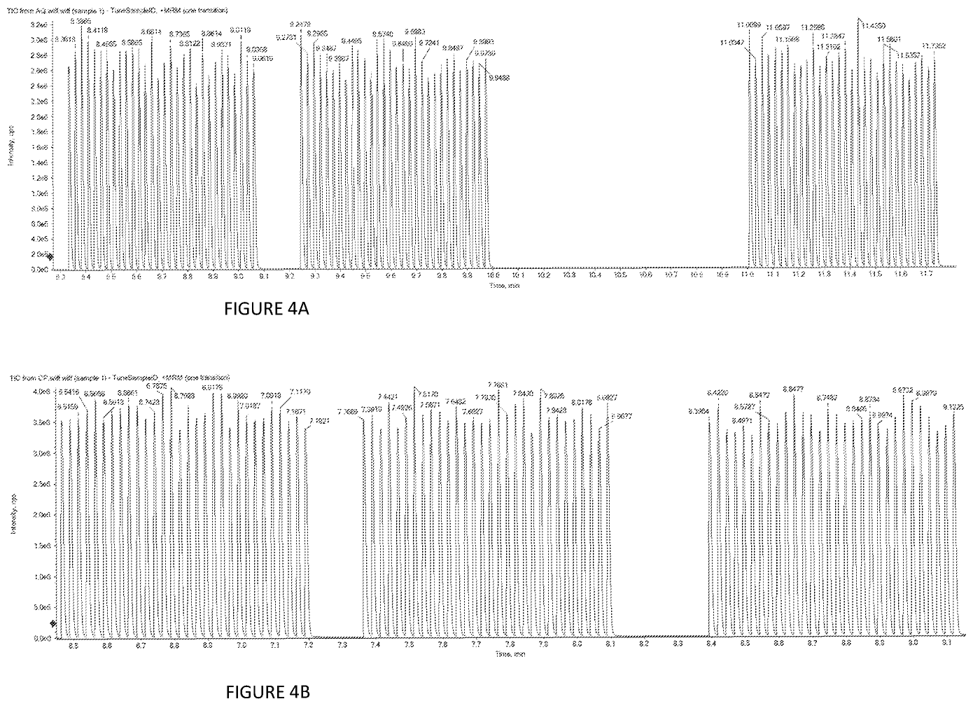

FIGS. 4A and 4B illustrate the results when an alkylation reagent (1 mM iodoacetamide) is added after the reduction step. As illustrated, the analysis peaks produced after introduction of the alkylation reagent are consistent throughout the sampling period with the ADE operating in both the aqueous (AQ) mode and more general (CP) mode.

In general, a system that performs the methods described herein may include: a plate handler operative to receive a microtiter well plate: a liquid handler operative to introduce a reducing agent into at least one sample well of the well plate to perform a reduction reaction in the at least one sample well and to introduce an alkylation reagent into the at least one sample well to perform an alkylation reaction in the at least one sample well, and, an acoustic droplet ejector (ADE) operative to eject sample from the at least one sample well after the alkylation reaction has been completed.

The system may further include an open port interface (OPI) situated to capture ejected sample, dilute the captured sample, and transfer diluted sample to an ionization source for ionization.

A system may also include: a plate handler operative to receive a microtiter well plate: a liquid handler operative to introduce a reducing agent into at least one sample well of the well plate to perform a reduction reaction in the at least one sample well: an acoustic droplet ejector (ADE) operative to eject sample from the at least one sample well: a housing enclosing and isolating the sample wells of the microtiter well plate from ambient air: and, a non-reactive gas source in fluid connection with an interior of the housing to supply non-reactive gas, such as nitrogen for instance, to isolate the sample wells from reactive gases in the ambient air.

The system may further include an open port interface (OPI) situated within the housing to capture ejected sample, dilute the captured sample, and transfer diluted sample to an ionization source for ionization. The ejecting of sample from the sample well to the OPI being through the non-reactive gas isolating the sample well from the ambient air outside of the housing.

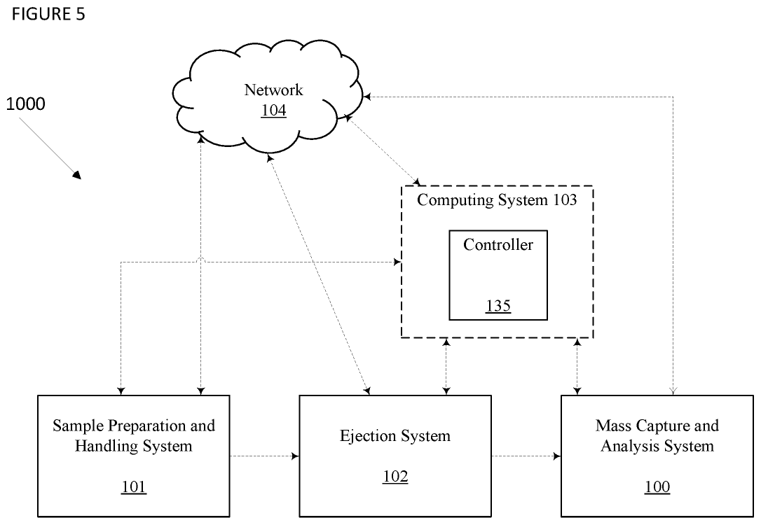

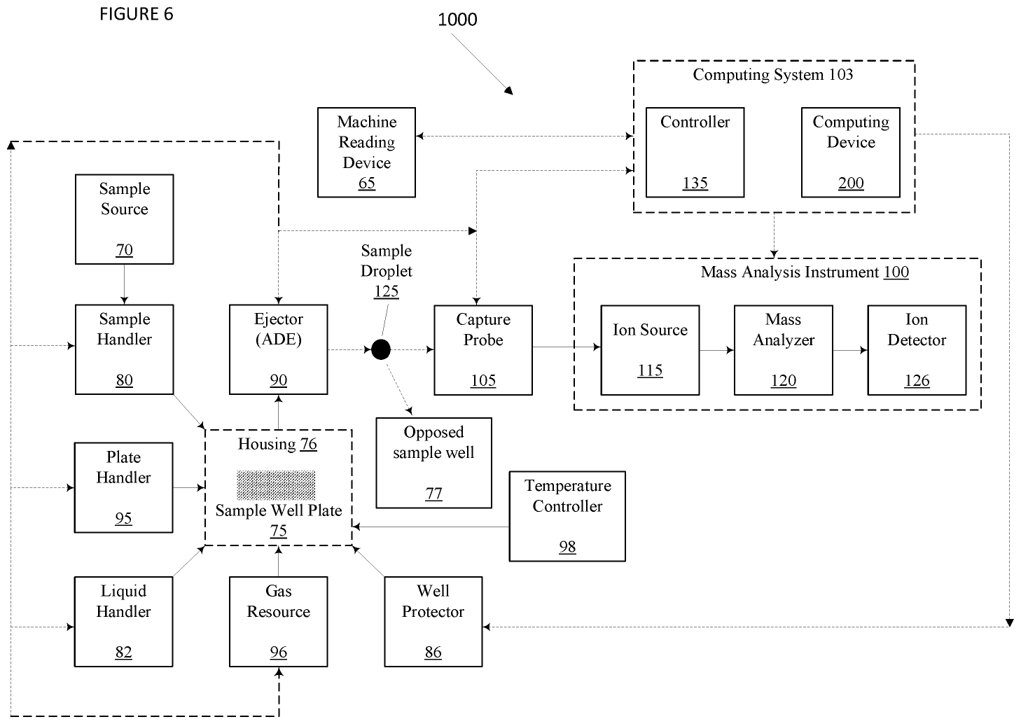

Specific implementations of mass analysis systems are depicted in FIGS. 5 and 6 Such systems 1000 can include, in various combinations, pluralities of components or subsystems, including some or all of: a sample preparation and handling system 101, an ejection system 102, a mass capture and analysis system 100, a computing system 103 comprising a controller 135, and a network 104. The various components or subsystems of the systems 1000 may be communicatively connected with each other.

The network 104 may be operably connected to any one or all of the subsystems or components in the systems 1000. The network 104 is a communication network. In the exemplary embodiment, the network 104 is a wireless local area network (WLAN). The network 104 may be any suitable type of network and/or a combination of networks. The network 104 may be wired or wireless and of any communication protocol. The network 104 may include, without limitation, the Internet, a local area network (LAN), a wide area network (WAN), a wireless LAN (WLAN), a mesh network, a virtual private network (VPN), a cellular network, and/or any other network that allows system 1000 to operate as described herein.

The sample preparation and handling system 101 may include one or more sample sources 70: sample handler(s) 80 for retrieving collections of samples from the sample source(s) and delivering retrieved collections to capture locations associated with sample capture devices or probes 105. The systems 1000 may be operative to independently capture selected ones of the pluralities of samples at the capture locations from the pluralities of samples, to optionally dilute the samples and to transfer the captured samples to mass capture and analysis system 100 for mass analysis. The computing system 103 and/or controller 135 in the form of electronic signal processors may be operative to coordinate some or all of the operations of the pluralities of the various components.

The mass capture & analysis system 100 includes an ion source 115, a mass analyzer 120, and an ion detector 126. The mass capture & analysis system 100 is operative to receive the captured sample, generate ionized products of the captured sample, and analyze mass of the ionized products. The mass capture and analysis system 100 may also include a capture device or probe 105 that captures the sample and provides the sample to other components of the mass capture and analysis system 100. In other examples (such as shown in FIG. 6), the capture probe 105 may be located externally from the mass capture and analysis system 100. For instance, the capture probe 105 may be part of the ejection system 102.

It will also be appreciated by a person skilled in the art and in light of the teachings herein that the mass analyzer 120 can have a variety of configurations. Generally, the mass analyzer 120 is configured to process (e.g., filter, sort, dissociate, detect, etc.) sample ions generated by the ion source 115. By way of non-limiting example, the mass analyzer 120 can be a triple quadrupole mass spectrometer, or any other mass analyzer known in the art and modified in accordance with the teachings herein. Other non-limiting, exemplary mass spectrometer systems that can be modified in accordance with various aspects of the systems, devices, and methods disclosed herein can be found, for example, in an article entitled “Product ion scanning using a Q-q-Q linear ion trap (Q TRAP) mass spectrometer,” authored by James W. Hager and J. C. Yves Le Blanc and published in Rapid Communications in Mass Spectrometry (2003:17: 1056-1064); and U.S. Pat. No. 7,923,681, entitled “Collision Cell for Mass Spectrometer,” the disclosures of which are hereby incorporated by reference herein in their entireties.

Other configurations, including but not limited to those described herein and others known to those skilled in the art, can also be utilized in conjunction with the systems, devices, and methods disclosed herein. For instance, other suitable mass spectrometers include single quadrupole, triple quadrupole, ToF, trap, and hybrid analyzers. It will further be appreciated that any number of additional elements can be included in the system 100 including, for example, an ion mobility spectrometer (e.g., a differential mobility spectrometer) that is disposed between the ionization source 115 and the mass analyzer detector 120 and is configured to separate ions based on their mobility difference between in high-field and low-field). Additionally, it will be appreciated that the mass analyzer 120 can comprise a detector 126 that can detect the ions that pass through the analyzer 120 and can, for example, supply a signal indicative of the number of ions per second that are detected.

The sample preparation system 101 may include one or more sample sources 70, a sample handler 80, and optionally a liquid handler 82. The sample source 70 may include a set of well plates 75 in a storage housing and/or fluid for adding to well plates. The sample source 70 may include part of a fluid handling system that manipulates and/or injects and/or introduces fluid into the well plates. The sample handler 80 includes one or more electro-mechanical devices (e.g., robotics, conveyor belts, stages, etc.) that are capable of transferring the samples (e.g., well plates) from the sample source to other components of the sample preparation system 101 and/or to other systems, such as the ejection system 102 and/or the capture probe 105.

The liquid handler 82 is operative to introduce at least one assisting agent into at least one sample well of the well plate 75. The assisting agent used herein refers to one or more chemicals that are introduced in the well and combined with the sample to benefit sample preparation, handling, and analysis. The assisting agent may be from a different sample source 70. The liquid handler 82 may include at least one of an automated multi-pipetting robot, an automated dispensing device, and an acoustic dispenser. In operation, the liquid handler 82 upon receiving an order or instruction from the controller 135, may automatically transfer a determined amount of the assisting agent from a sample source 70 to a target well of the well plates. These automated devices may be used to conveniently introduce the desired assisting agents into multiple wells of the well plate at one time. Alternatively, the liquid handler 82 may include a manual dispensing device commonly used in sample transfer operation, and the assisting agent is introduced manually into the target wells.

In one particular embodiment, the sample handler 80 is operative to sequentially introduce the sample and the assisting agent into the same well from different sample sources 70. In such cases, no liquid handler is needed to transfer the assisting agent. The assisting agent may be added to the same well before, or after, or simultaneously with the introduction of the sample.

The mixture of the sample and the assisting agent both introduced to the same sample well may undergo physical, chemical, or biochemical reactions, by which the sample liquid and/or the analytes thereof are stabilized by the assisting agent for the subsequent ejection and mass analysis. For example, the assisting agent may be effective to prevent gel formation at the top surface of the sample volume in the sample well, prior to the mixture ejection. Non-limiting examples of the assisting agent include a reducing agent, an alkylation agent, a blocking agent, a buffer, an enzyme, a substrate, a co-factor, a stabilizer, a viscosity-modifying agent, and combinations thereof. In some embodiments, two or more assisting agents are introduced into the same sample well through use of the sample handler 80 or the liquid handler 82. For example, a reducing agent may be introduced into the sample containing a biomolecule analyte having at least a S—S or a S—H group: and an alkylation agent may be introduced subsequently into the same sample to convert the S—H group into a more stable S—R group, wherein R is the alkyl group derived from the alkylation agent.

In one example, the sample handler 80 or the liquid handler 82 is operative to introduce a first assisting agent into the sample well. The first assisting agent may include a reducing agent dithiothreitol (DTT) that is allowed to react with the analytes of the sample to form S—H groups. The sample preparation and handling system 101 may be further operative to mix the reducing agent with the sample, maintain the reaction at an optimal temperature for reaction incubation, maintain the reaction in a non-reactive gas environment, and/or introduce additional or different assisting agents into the same sample well. Upon sufficient reaction incubation, the sample handler 80 or the liquid handler 82 is operative to introduce a second assisting agent into the sample well. The second assisting agent may include an alkylation agent capable of converting at least a portion of the S—H groups into more stable S—R groups, wherein R is the alkyl group derived from the alkylation agent. The alkylation agent may be added to the sample well prior to sample ejection.

The sample preparation system 101 may further include a housing 76 at least partially enclosing the well plate 75 to protect the wells and sample/assisting agents therein from external environment. In some embodiments, the housing 76 may at least partially enclose the system 1000, such that the introduction of the sample and the assisting agent, the ejection of sample from the well, or the delivery of the sample droplet may be performed substantially in the housing 76. In one particular example, the housing is a glove box free from oxygen, water, and carbon dioxide. The well plate is transferred into the glove box, where the sample or assisting agent or both are introduced into the wells by the sample handler 80 and/or the liquid hander 82. The well plate may stay in the housing 76 for a sufficient period of time for the assisting agent to take effect before transferring the well plate out from the housing. In another example, the housing 76 may be operatively connected to the controller 135. Upon receiving a signal from the controller 135, the housing 76 in response is automatically open for the well plate to be transferred therein, wherein introduction of the sample and/or assisting agent is performed after the housing 76 is closed. Upon receiving a signal indicating the sample and the assisting agent are introduced and the resultant mixture is ready for ejection, the housing 76 is automatically open for the well plate 75 to be transferred out to the ejector 90.

The sample preparation system 101 may further include a non-reactive gas source 96 communicatively coupled to an interior of the housing 76. The non-reactive gas source 96 is operative to introduce a non-reactive gas from the non-reactive gas source to the interior of the housing. Non-limiting examples of the non-reactive gas may include nitrogen or an inert gas such as argon. The non-reactive gas may be used to purge the housing once the well plate 75 is transferred in and before the introduction of sample or assisting agent. In particular, when the assisting agent is a reduction agent, the non-reactive gas is effective in protecting the reduction agent and prolonging the life time thereof. In one example, the non-reactive gas source 96 is operatively connected to the controller 135. Upon receiving a signal from the controller 135, the non-reactive gas source 96 in response is automatically activated to introduce the non-reactive gas into the housing 76 at a pre-determined rate for a pre-set amount of time. The non-reactive gas source 96 may continue to supply the non-reactive gas throughout sample preparation, ejection, transfer, until the sample droplet is captured by the capture probe 105. In another example, the housing 67 is a glove box that is filled with a non-reactive gas supplied by the non-reactive gas source 96 in gas communication with the glove box.

The sample preparation system 101 may further include a well protector 86 operative to apply and remove a seal or cover from the well plate 75. In one example, the well protector 86 may apply a non-transparent cover to seal the well plate 75 immediately upon completion of the introduction of the assisting agent and the sample into the wells of the well plate. The non-transparent cover protects the reaction mixture that may be sensitive to light and atmosphere. Once the mixture of the sample and the assisting agent is ready for ejection, the well protector 86 may remove the non-transparent cover from the well plate before transferring the well plate to the ejector 90. The well protector 86 may be operatively connected to the controller 135. Upon receiving a signal from the controller 135, the well protector 86 may automatically apply or remove the seal. Alternatively, the seal or cover may be applied and removed manually by an operator.

The sample preparation system 101 may further include a temperature controller 98 comprising a heating element. The temperature controller 98 is operative to control the temperature of the well plate and the wells and to maintain the temperature at a desired level or range for a determined amount of time. In some example, the temperature controller 98 may heat the well plate to an elevated temperate to facilitate the reduction or alkylation reactions of the sample with the assisting agent(s).

Once the mixture of the sample and the assisting agent in the wells are ready for ejection, the sample handler 80 and/or the liquid handler 82 may transfer the well plate 75 from the sample preparation system 101 to the ejection system 102. More specifically, the sample handler 80 and/or the liquid handler 82 may transfer the well plate to a plate handler 95 of the ejection system 102. Accordingly, the sample preparation system 101 may also be referred to as a sample delivery system.

In addition to the plate handler 95, the ejection system 102 may include an ejector 90 that ejects droplets from the wells of the well plates. The ejector 90 may be any type of suitable ejector, such as an acoustic ejector or a pneumatic ejector. In an example, the plate handler 95 receives a well plate from the sample handler 80 and/or the liquid handler 82. The plate handler 95 transports the plate to a capture location that may be aligned with the capture probe 105. Once in the capture location, the ejector 90 ejects droplets 125 from one or more wells of the well plates. The sample droplet 125 comprises the mixture of the sample and the assisting agent introduced in the same well. As discussed above, the mixture may include stabilized analytes of the sample. The plate handler 95 may include one or more electro-mechanical devices, such as a translation stage that translates the well plate in an x-y plane to align wells of the well plate with the ejector 90 and/or or the capture probe 105.

In some embodiments, the plate handler or stage 95 is provided at the capture location: the stage for locating or placing individual samples from the collection of samples in alignment with, or in other operating proximity with respect to, a sample ejector 90 and a capture probe 105: the sample ejector operative 90 to eject one or more sample droplets 125 from the located individual sample into the capture probe 105: the capture probe 105 operative to capture, optionally dilute, and transport the sample droplets 125 to a mass capture and analysis system 100 for mass analysis.

The systems 1000 may further include an additional plate handler (not shown) similar to the plate handler 95. The additional plate handler is operative to locate an opposed sample well 77 to capture the ejected sample for subsequent storage, processing, and/or analysis. The opposed sample well 77 may be located to capture the ejected sample through a non-reactive gas surrounding the sample well. In one example, the opposed sample well 77 is located in the housing 76 filled with a non-reactive gas supplied by the non-reactive gas source 96 described herein.

In some aspects, the system may further comprise the generation, assignment, and use of identifiers associated with collections of samples and/or individual samples, and incorporation by one or more of components 70, 80, 82, 86, 95, 96, 98, 105, 100, etc. of identifier readers. For instance, an identifier associated with a well plate may be read or scanned as it leaves the sample source 70 and/or when the well plate is received by the stage 95. In such aspects, the identifier(s) may be used by the system to associate a corresponding one or more sets of instructions for use by the mass capture and analysis system 100 when analyzing transported sample droplets 125. In some aspects, the identifier may comprise an indicia physically associated with the plurality of samples. In some aspects, the indicia may be readable by optical, electrical, magnetic or other non-contact reading means. Indicia or identifiers in accordance with such aspects of the disclosure can include any characters, symbols, or other devices suitable for use in adequately identifying samples, sample collections, and/or handling or analysis instructions suitable for use in implementing the various aspects and embodiments of the invention.

A particular embodiment of the system 1000, according to FIGS. 5 and 6, includes a sample handler 80, a liquid handler 82, and an associated controller 135, which may be, for example, a Biomek computer available from Beckman Coulter Life Sciences, is in operative communication with a mass capture and analysis system 100 and a controller for the capture probe 105, which may include, for example, an a SciexOS® or Analyst® computer available from Sciex. The Analyst® or SciexOS® computer includes a control component for the capture probe 105, represented for example by Sciex open port probe (OPP) (also referred to as an open port interface (OPI)) software, and a control component for the mass capture and analysis system, which may be the Analyst R: computer. The mass capture and analysis system and capture probe controller may be further in operative communication with an ejector 90 and an X-Y Well Plate Stage 95 and plate handler controller, which may be, for example, an EDC liquid droplet ejector with embedded computer or processor. For the purposes of this application, these distributed controller components may collectively be considered to be a system controller, and depending upon the configuration may be centralized, or distributed as is the case here. For instance, one of the controllers or controller components may send signals to the other controllers to control the respective devices. As an example, the controller 135 may be a controller originally configured for the control of the sample preparation system 101 (e.g., sample handler 80, liquid handler 82, housing 76, gas source 96, well protector 86, temperature controller 98, and/or the sample sources 70) and may be used as the primary controller for controlling components in addition to those components in the sample preparation system 101, such as the mass capture and analysis system 100 and the ejection system. As another example, the controller 135 may be a controller for the mass capture and analysis system 100 and may be used as the primary controller for controlling components in addition to those components housed within the mass capture and analysis system 100. As such, one controller may be considered the main or central controller that orchestrates, or communicates with, the other controllers to carry out the operations discussed herein in a more efficient manner.

The mass capture and analysis system 100 includes an electro-mechanical instrument for separating and detecting ions of interest from a given sample. The mass capture and analysis system 100 may be associated with computing system 103 operative to carry out both control of the system components and to receive and manage the data generated by the mass capture and analysis system 100. In the embodiment of FIG. 6, the computing system 103 are illustrated as having separate modules: a controller 135 for directing and controlling the system components and a data handler 140 for receiving and assembling a data report of the detected ions of interest. Depending upon requirements, the computing system 103 may comprise more or fewer modules than those depicted, may be centralized or otherwise share processing, control, and/or memory resources, or they may be distributed across the system components depending upon requirements. Typically, a detected ion signal generated by the ion detector 126 is formatted in the form of one or more mass spectra based on control information as well as other process information of the various system components. Subsequent data analysis using a data analyzer (not illustrated in FIG. 6) may subsequently be performed on a data report (e.g. on the mass spectra) in order to interpret the results of the mass analysis performed by the mass capture and analysis system 100.

Also illustrated in FIG. 6 are components of a sample delivery system for use in combination with the mass capture and analysis system 100. The sample delivery system includes at least a sample source 70 for supplying a plurality of samples and/or assisting agents, a sample handler 80 and/or a liquid handler 82 for introducing samples and/or assisting agents to sample wells to form sample mixtures therein and for delivering a plurality of the sample mixtures to a capture location, and a capture probe 105 for independently capturing one or more sample mixtures. In some aspects, the sample delivery system may further include a stage 95 for locating each sample mixture for the plurality of samples mixtures proximate to a capture surface of the capture probe 105 and an ejector 90 for selectively ejecting that located sample mixture into the capture surface of the capture probe 105.

In operation, a sample delivery system (including sample source 70, sample handler 80, and optionally liquid handler 82) can iteratively deliver independent sample mixtures from a plurality of sample mixtures (e.g., a sample mixture from a well of a well plate 75) to the capture probe 105. The sample mixture of each well contains a reaction mixture of a sample and an assisting agent introduced into the well. The capture probe 105 can dilute and transport each such delivered sample mixture to the ion source 115 disposed downstream of the capture probe 105 for ionizing the diluted sample mixture. A mass analyzer 120 can receive generated ions from the ion source 115 for mass analysis. The mass analyzer 120 is operative to selectively separate ions of interest from generated ions received from the ion source 115 and to deliver the ions of interest to an ion detector 126 that generates a mass spectrometer signal indicative of detected ions to the data handler 140. In some aspects, the separate ions of interest may be indicated in an analysis instruction associated with that sample mixture. In some aspects, the separate ions of interest may be indicated in an analysis instruction identified by an indicia physically associated with the plurality of sample mixtures.

The data handler 140 may include one or more data analysis modules operative to perform the following non-limiting operations: acquire mass spectrometry data generated by the mass analyzer 120, convert the mass spectrometry data into mass spectra, analyze the mass spectra, annotate and assign m/z peaks, calculate m/z values, identify mass difference or relationship between or among correlated m/z peaks, extract spectral features from the mass spectra, perform library or database search, perform spectral comparison, identify the analytes of interest, calculate quality or similarity score. The data handler 140 is further operative to deduce the identity of the original analytes of the sample from the analytical results of the stabilized analytes generated from the reaction with the assisting agents (e.g., reducing agent and/or alkylation agent).

In one example, a sample being analyzed by the system 1000 may contain a protein analyte that has S—S or S—H groups. A reducing agent may be introduced through use of the sample handler 80 or the liquid handler 82 to the well to react with the protein analyte. The S—S groups of the protein analyte will be substantially cleaved to generate S—H groups. An alkylation agent may be subsequently introduced to the same well through use of the sample handler 80 or the liquid handler 82 to alkylate the S—H groups of the protein analyte and form more stable S—R groups. The system 1000 is operative to eject, transfer, and analyze the sample containing the alkylated protein analyte. The data handler 140 is operative to analyze the mass spectra of the sample and determine the identity of the alkylated protein analyte. Based on the known relationship between the original protein analyte and the alkylated analyte, the data handler 140 is further operative to deduce the identity (e.g., neutral mass) of the original protein analyte from the identified alkylated protein analyte.

Computing system 103 may comprise a single computing device 200 or may comprise a plurality of distributed computing devices in operative communication with components of a mass capture and analysis system 100. In such an example, computing system 103 may include a bus or other communication mechanism for communicating information, and at least one processing element coupled with bus for processing information. As will be appreciated by those skilled in the relevant arts, such at least one processing element may comprise a plurality of processing elements or cores, which may be packaged as a single processor or in a distributed arrangement. Furthermore, in some embodiments, a plurality of virtual processing elements may be provided to provide the control or management operations for the mass capture and analysis system 100.

Computing system 103 may also include one or more volatile memory(ies), which can for example include random access memory(ies) (RAM) or other dynamic memory component(s), coupled to one or more busses for use by the at least one processing element. Computing system 103 may further include static, non-volatile memory(ies), such as read only memory (ROM) or other static memory components, coupled to busses for storing information and instructions for use by the at least one processing element. A storage component, such as a storage disk or storage memory, may be provided for storing information and instructions for use by the at least one processing element. As will be appreciated, in some embodiments the storage component may comprise a distributed storage component, such as a networked disk or other storage resource available to the computing system 103.

Computing system 103 may be coupled to one or more displays for displaying information to a computer user. Optional user input devices, such as a keyboard and/or touchscreen, may be coupled to a bus for communicating information and command selections to the at least one processing element. An optional graphical input device, such as a mouse, a trackball or cursor direction keys for communicating graphical user interface information and command selections to the at least one processing element. The computing system 103 may further include an input/output (I/O) component, such as a serial connection, digital connection, network connection, or other input/output component for allowing intercommunication with other computing components and the various components of the mass capture and analysis system 100.

In various embodiments, computing system 103 can be connected to one or more other computer systems or a network to form a networked system. Such networks can for example include one or more private networks, or public networks such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass capture and analysis system 100 may be supported by operation of the distributed computing systems.

Computing system 103 may be operative to control operation of the components of the mass capture and analysis system 100 and the sample delivery components 70, 80, 82, 86, 95, 96, 98, 105 through controller(s) 135 and to handle data generated by components of the mass capture and analysis system 100 through data handler(s) 140. In some embodiments, analysis results are provided by computing system 103 in response to the at least one processing element executing instructions contained in memory and performing operations on data received from the mass capture and analysis system 100. Execution of instructions contained in memory by the at least one processing element can render the mass capture and analysis system 100 and associated sample delivery components operative to perform methods described herein. Alternatively, hard-wired circuitry may be used in place of or in combination with software instructions to implement the present teachings. Thus, implementations of the present teachings are not limited to any specific combination of hardware circuitry and software.

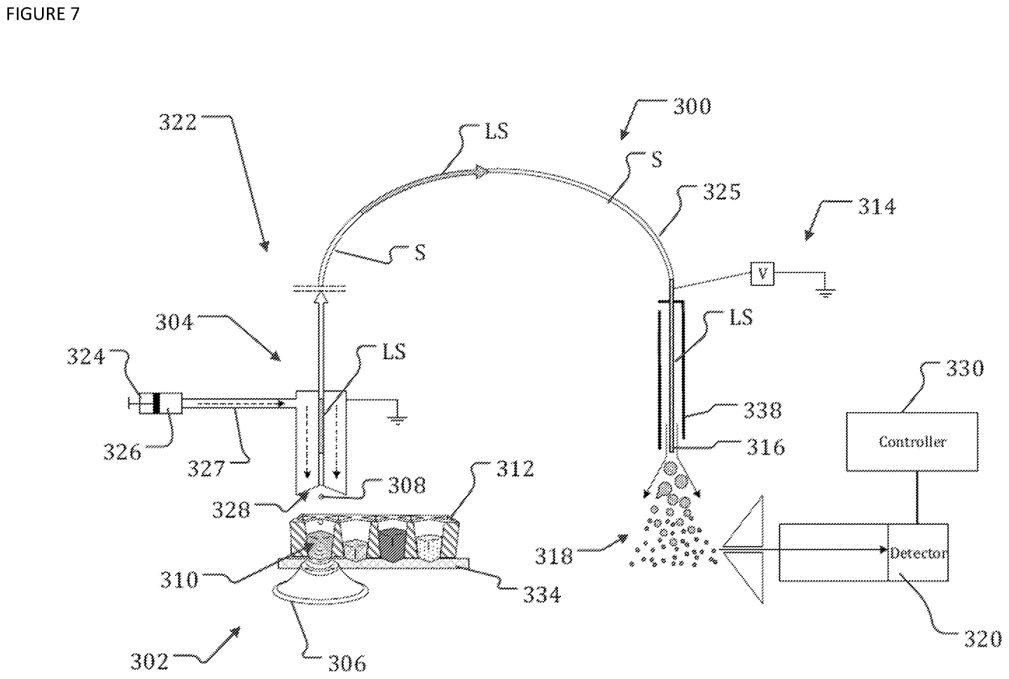

FIG. 7 depicts a schematic view of an example system 300 combining an acoustic droplet ejection (ADE) device 302 with an open port interface (OPI) 304 and an electrospray ionization (ESI) device source 314. The system 300 provides an example of an integration and physical connection between or among the sample preparation and handling system 101, the ejection system 102, the capture probe 105, and the mass capture and analysis system 100.

The ADE 302 includes an acoustic ejector 306 that is operative to eject a droplet 308 from a reservoir 312 into the open end of sampling OPI 304. The acoustic ejector 306 is one example of the ejector 90, and the sampling OPI 304 is one example of the capture probe 105. As shown in FIG. 7, the example system 300 generally includes the sampling OPI 304 in liquid communication with the ESI source 314 for discharging a liquid containing one or more sample analytes (e.g., via electrospray electrode 316) into an ionization chamber 318, and a mass analyzer detector (depicted generally at 320) in communication with the ionization chamber 318 for downstream processing and/or detection of ions generated by the ESI source 314. The ESI source 314 is an example of the ion source 115, and the mass analyzer detector 320 is an example of the ion detector 126.

Due to the configuration of the nebulizer probe 338 and electrospray electrode 316 of the ESI source 314, samples ejected therefrom are in the gas phase. The system 300 includes a liquid handling system 322, which represents a part of the sample preparation and handling system 101 of FIG. 5. The liquid handling system 322 (e.g., including one or more pumps 324 and one or more conduits 325) provides for the flow of a transport fluid or liquid from a solvent reservoir 326 to the sampling OPI 304 and from the sampling OPI 304 to the ESI source 314. The solvent reservoir 326 (e.g., containing a liquid, desorption solvent) can be liquidly coupled to the sampling OPI 304 via a supply conduit 327 through which the transport fluid or liquid can be delivered at a selected volumetric rate by the pump 324 (e.g., a reciprocating pump, a positive displacement pump such as a rotary, gear, plunger, piston, peristaltic, diaphragm pump, or other pump such as a gravity, impulse, pneumatic, electrokinetic, and centrifugal pump), all by way of non-limiting example. The flow of transport fluid or liquid into and out of the sampling OPI 304 occurs within a sample space accessible at the open end such that one or more droplets 308 can be introduced into the liquid boundary 328 at the sample tip and subsequently delivered to the ESI source 314.

The ADE 302 is configured to generate acoustic energy that is applied to a liquid contained within a well or reservoir 310 of a well plate 312 that causes one or more droplets 308 to be ejected from the reservoir 310 into the open end of the sampling OPI 304. The liquid in the well may be a sample mixture comprising a reaction mixture of a sample and one or more assisting agents. The well plate 312 is an example of the well plates 75 of FIGS. 5-6. The acoustic energy is generated from an acoustic ejector 306, which is an example of the ejector 90 discussed above. The well plate 312 may reside on a movable stage 334, which is an example of the plate stage 95 discussed above.

A controller 330 can be operatively coupled to the ADE 302 and can be configured to operate any aspect of the ADE 302 (e.g., focusing structures, acoustic ejector 306, automation elements for moving a movable stage 334 so as to position a reservoir 310 into alignment with the acoustic ejector 306 and/or the OPI 304, etc.). This enables the ADE 302 to eject droplets 308 into the sampling OPI 304 as otherwise discussed herein substantially continuously or for selected portions of an experimental protocol by way of non-limiting example. Controller 330 can be, but is not limited to, a microcontroller, a computer, a microprocessor, or any device capable of sending and receiving control signals and data. Wired or wireless connections between the controller 330 and the remaining elements of the system 300 are not depicted but would be apparent to a person of skill in the art. The controller 330 may be any of the controllers discussed above and may be responsible for controlling the mass capture and analysis system 100 and/or the sample preparation and handling system 101 as well.

As shown in FIG. 7, the ESI source 314 can include a source 336 of pressurized gas (e.g., nitrogen, air, or a noble gas) that supplies a high velocity nebulizing gas flow to the nebulizer probe 338 that surrounds the outlet end of the electrospray electrode 316. As depicted, the electrospray electrode 316 protrudes from a distal end of the nebulizer probe 338. The pressured gas interacts with the liquid discharged from the electrospray electrode 316 to enhance the formation of the sample plume and the ion release within the plume for sampling by mass analyzer detector 320, e.g., via the interaction of the high-speed nebulizing flow and jet of liquid sample (e.g., analyte-solvent dilution). The liquid discharged may include discrete volumes of liquid samples LS received from each reservoir 310 of the well plate 312. The discrete volumes of liquid samples LS are typically separated from each other by volumes of the solvent S (hence, as flow of the solvent moves the liquid samples LS from the OPI 304 to the ESI source 314, the solvent may also be referred to herein as a transport fluid). The nebulizer gas can be supplied at a variety of flow rates, for example, in a range from about 0.1 L/min to about 20 L/min, which can also be controlled under the influence of controller 330 (e.g., via opening and/or closing valve 340).

It will be appreciated that the flow rate of the nebulizer gas can be adjusted (e.g., under the influence of controller 330) such that the flow rate of liquid within the sampling OPI 304 can be adjusted based, for example, on suction/aspiration force generated by the interaction of the nebulizer gas and the analyte-solvent dilution as it is being discharged from the electrospray electrode 316 (e.g., due to the Venturi effect). The ionization chamber 318 can be maintained at atmospheric pressure, though in some examples, the ionization chamber 318 can be evacuated to a pressure lower than atmospheric pressure.

The present disclosure provides methods for handling and/or analyzing samples for mass analysis. In particular, the present methods can be implemented through use of the present systems 1000 or any subsystems or components thereof as described above.

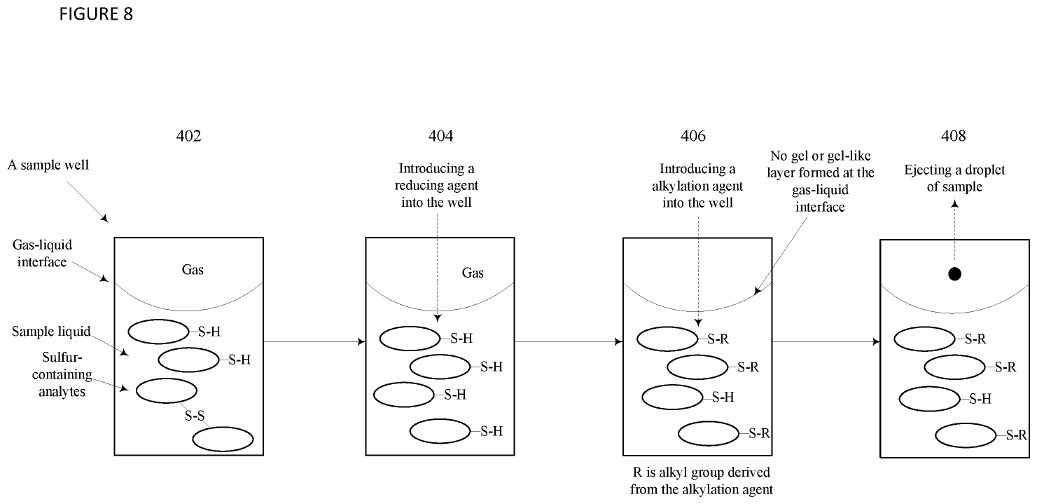

FIG. 8 is a general scheme illustrating one example approach adopted by the present methods for handling and analyzing a sample. In the illustrated example, a sample 402 is placed in a sample well of a well plate at 402. The sample is a in a liquid form and has a sample volume in the well. A gas-liquid interface is formed at the top of the sample volume. The sample contains an analyte such as a biomolecule that has at least one S—H (thiol) or S—S (disulfide) group. Non-limiting examples of the biomolecule analyte include protein, peptide, amino acid, a molecule having one or more amino acid moieties, proteomic metabolites and derivatives, etc. For example, a protein incorporating methionine, cysteine, homocysteine, or taurine may have a thiol or a disulfide group. Without intervention e.g., through use of an assisting agent, the protein analytes of the sample may remain active in the sample volume, gradually aggregate through intramolecular S—S coupling, and eventually form unfavorable aggregates or gel-like material at the gas-liquid interface, which may significantly increase the viscosity of the sample liquid and affect/obstruct the ejection of the sample droplet from the sample well.

To prevent gel formation at a top surface of the sample volume before the sample ejection, at least one assisting agent may be introduced into the sample well to react with the sample and/or stabilize the analytes through functional group modification. Non-limiting examples of the assisting agent include a reducing agent, an alkylation agent, a blocking agent, a buffer, an enzyme, a substrate, a co-factor, a stabilizer, a viscosity-modifying agent, or combinations thereof.

For example, a proper amount of reducing agent may be introduced into the sample well at 404. The reducing agent may be dithiothreitol (DTT), dithioerythritol (DTE), tris (2-carboxyethyl) phosphine hydrochloride (TCEP), 2-mercaptoethanol, 2-mercaptoethylamine, thioglycolic acid, cysteine, guanidine, urea, or any salt or derivative thereof, or any combinations thereof. The reducing agent is functioned to convert the S—S group into S—H group and/or provide a reductive environment to prevent the S—H group from being oxidized or being coupled to another S—H group. Optionally, an alkylation agent may be added to the same sample well after the reducing agent takes effect. Non-limiting examples of the alkylation agent include iodoacetamide, iodoacetic acid, acrylamide, chloroacetamide, or any combination thereof. The alkylation agent is functioned to partially or substantially alkylate the S—H groups of the analytes, forming more stable S—R groups, wherein R is the alkyl group derived from the alkylation agent. The analytes having more stable S—R groups are substantially stabilized and may protect the sample mixture from thickening or generating gelled particles or layer through intramolecular S—S coupling. A droplet of the sample mixture containing stabilized analytes is ejected from the sample well and subjected to sample transfer, capture, and mass analysis.

In some embodiments, the assisting agent(s) introduced to the sample well (such as reducing agent or alkylation agent) is substantially or nearly completely consumed in the reaction with the analytes prior to sample ejection, and the ejected sample droplet includes the modified or stabilized analytes from the reaction (e.g., protein analyte with the more stable S—R groups) but is free or substantially free from the assisting agent. In other embodiments, at least a portion of the introduced assisting agent remains unconsumed in the sample well upon completion of reaction or incubation, and the sample droplet may include both stabilized analytes and the unconsumed assisting agents.

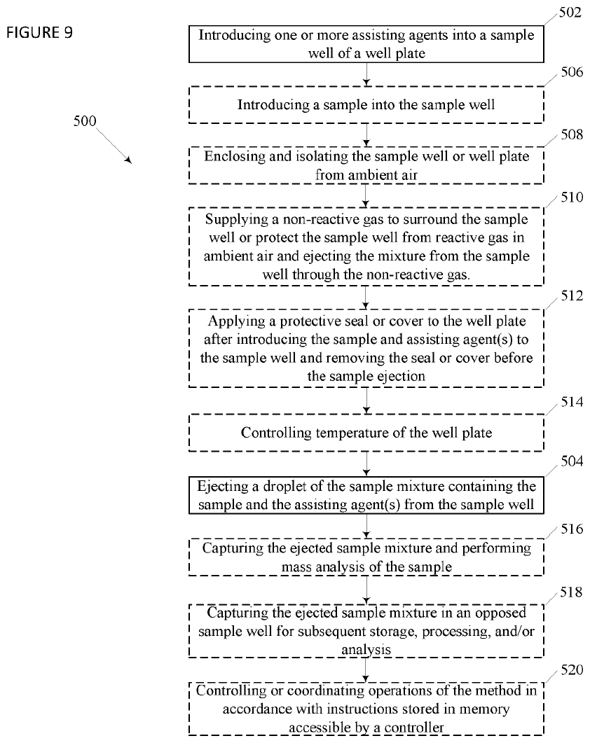

FIG. 9 illustrates a flow diagram of one particular example of a method for handling and/or analyzing samples. In the illustrated example, a method 500 includes operations 502 and 504. At 502, at least one assisting agent is introduced into a sample well of a well plate, e.g., through use of a sample handler 80 or a liquid handler 82 of the present system 1000. At 504, a sample mixture containing a sample and the assisting agent(s) is ejected from the sample well. The at least one assisting agent interacts with an analyte of the sample to limit gel formation at a top surface of the sample volume, prior to the mixture ejection.

The method 500 may further include operation 506, at which, a sample is introduced into the sample well where the assisting agent is introduced thereto. The introduction of the sample may be performed through use of the sample handler 80 of the present system 1000. Operation 502 and 506 may be performed sequentially, separately, or simultaneously. For example, a sample may be introduced into a sample well containing an assisting agent that has been introduced thereto. Alternatively, an assisting agent may be introduced into a sample well containing a sample that has been introduced thereto. Two or more assisting agents may be introduced to the same sample well. For example, a reducing agent may be introduced into a sample well at 502 to react with a sample containing an target analyte that has S—H or S—S groups. The reducing agent interacts with the analyte to reduce the S—S groups to S—H groups and to protect the S—H groups from oxidation and/or S—S coupling. An alkylation agent may be subsequently introduced into the sample well at 502 to alkylate the S—H groups of the analyte to stabilize the analyte. A droplet of the sample mixture containing the stabilized analyte is ejected from the sample well at 504. In some embodiments, the reducing agent and the alkylation agent introduced to the sample well are substantially consumed or depleted in the reaction, and the droplet of the sample mixture may be free or substantially free from the reducing agent and the alkylation agent.

The method 500 may further include operation 508, at which, the sample well or well plate is at least partially enclosed in a housing and/or isolated from ambient air or light, e.g., through use of the housing 76 of the present system 1000. Operation 508 may be performed automatically upon receiving a signal from the controller 135. Alternatively, operation 508 may be performed manually by an operator, e.g., transferring the well plate into a glove box. Operation 510 may be performed prior to operations 502 and/or 506, such that the sample and/or assisting agent are introduced into the sample well within the housing.

The method 500 may further include operation 510. Operation 510 includes supplying a non-reactive gas to surround the sample well or protect the sample well from reactive gas in ambient air: and ejecting the mixture from the sample well through the non-reactive gas. Operation 510 may be performed prior to any or all of operations 502, 504, and 506, such that the sample preparation, handling, or ejection are performed under the protection of the non-reactive gas. Operation 510 may be coordinately performed with operation 508. For example, the non-reactive gas source may be communicatively coupled to an interior of the housing of operation 508, operation 510 includes introducing a non-reactive gas from the non-reactive gas source to the interior of the housing. Operation 510 may be performed through use of the non-reactive gas source 96, either manually or automatically upon receiving an instruction from the controller 135.

It is noted that, under the protective environment at 508 and/or 510, the reducing agent introduced to the sample well at 504 may be sufficient to stabilize analytes of the sample for sample ejection and analysis. Thus, when the sample well is placed in the housing at 508 or is protected by a non-reactive gas at 510, introduction of the alkylation agent may be unnecessary or optional prior to sample ejection. Alternatively, when the alkylation agent is introduced into the sample well at 504 to sufficiently stabilize the sample, operations 508 and 510 may be unnecessary or optional.

The method 500 may further include operation 512. Operation 512 includes: applying a protective seal or cover to the well plate after introducing the sample and assisting agent(s) to the sample well, and removing the seal or cover before the sample ejection. Operation 512 may be performed through use of the well protector 86 of the present system 1000. The protective seal or cover is used to protect the reaction mixture from light, ambient air, dirt or contaminant from the external environment. Operation 512 may be performed either manually or automatically upon receiving an instruction from the controller 135.

The method 500 may further include operation 514, at which temperature of the well plate is controlled at a desired range or level to facilitate the sample incubation or reaction of the sample with the assisting agent. Operation 514 may be performed through use of the temperature controller 98 of the present system 1000. Operation 514 may be performed either manually or automatically upon receiving an instruction from the controller 135.

The method 500 may further include operation 516. Operation 516 includes capturing the ejected sample mixture and performing mass analysis of the sample. Operation 516 may be performed through use of the capture probe 105 and the mass capture and analysis system 100 of the present system 1000. In one example, the capture probe 105 is an OPI described herein.

The method 500 may further include operation 518. Operation 518 includes capturing the ejected sample mixture in an opposed sample well for subsequent storage, processing, and/or analysis. Operation 518 may be performed through use of the additional plate handler to capture the ejected sample mixture in the opposed sample well 77 of the present system 1000.

The method 500 may further include operation 520. Operation 520 includes controlling or coordinating operations of the method 500 in accordance with instructions stored in memory accessible by a controller, e.g., controller 135 of the present system 1000.

Although various embodiments and examples are described herein, those of ordinary skill in the art will understand that many modifications may be made thereto within the scope of the present disclosure. Accordingly, it is not intended that the scope of the disclosure in any way be limited by the examples provided.

What is claimed is:

1. A system for analyzing a sample, the system comprising:
a first plate handler;
a liquid handler;
an acoustic droplet ejector (ADE);
an open port interface (OPI);
a mass capture and analysis system;
a processor operatively coupled to each of the first plate handler, the liquid handler, the ADE, the OPI, and the mass capture and analysis system; and
memory, operatively connected to the processor, the memory storing instructions that, when executed by the processor, perform a set of operations comprising:
receiving, by the first plate handler, a well plate comprising a plurality of sample wells, each sample well configured to contain a sample having a sample volume;
introducing, by the liquid handler, at least one assisting agent into at least one sample well;
ejecting, with the ADE, a mixture comprising the sample and the at least one assisting agent from the at least one sample well and into the OPI for transport to the mass capture and analysis system; and
detecting, with the mass capture and analysis system, at least one analyte of the mixture.

2. The system of claim 1, further comprising a sample handler, wherein the set of operations further comprises introducing, with the sample handler, the sample into the at least one sample well.

3. The system of claim 2, wherein the set of operations further comprises introducing, with the liquid handler, the at least one assisting agent into the at least one sample well, at least one of:
before introduction of the sample to the at least one sample well,
after introduction of the sample to the at least one sample well, and
simultaneously with introduction of the sample to the at least one sample well.

4. The system of claim 1, wherein the mixture is transported from the OPI to the mass capture and analysis system via a transfer conduit.

5. The system of claim 1, wherein the set of operations further comprises introducing a transport liquid to the OPI, and wherein the mixture is diluted in the transport liquid during transport of the mixture to the mass capture and analysis system.

6. The system of claim 1, further comprising a housing at least partially enclosing the well plate.

7. The system of claim 6, further comprising a non-reactive gas source communicatively coupled to an interior of the housing, and wherein the set of operations further comprises:
introducing a non-reactive gas from the non-reactive gas source to the interior of the housing.

8. (canceled)

9. The system of claim 1, further comprising a protector for selectively applying and removing a seal from the well plate.

10. The system of claim 1, wherein the liquid handler comprises at least one of an automatic pipetting robot, an automated dispensing device, and an acoustic dispenser.

11. A method for handling a sample for analysis, the method comprising:
introducing, with a liquid handler, at least one assisting agent into a sample well of a well plate, wherein the sample comprises a sample volume; and
ejecting, with an acoustic droplet ejector (ADE), a mixture comprising the sample mixed with the at least one assisting agent from the sample well, wherein the at least one assisting agent interacts with an analyte of the sample to limit gel formation at a top surface of the sample volume, prior to the mixture ejection.

12. The method of claim 11, further comprising introducing the sample into the sample well; wherein the at least one assisting agent prevents gel formation at the top surface of the sample volume, prior to the mixture ejection.

13. (canceled)

14. The method of claim 11, further comprising:
supplying a non-reactive gas to isolate the sample well from reactive gas in ambient air; and
ejecting the mixture from the sample well through the non-reactive gas.

15. The method of claim 11, wherein the at least one assisting agent is selected from the group consisting of: a reducing agent, an alkylation agent, a blocking agent, a buffer, an enzyme, a substrate, a co-factor, a stabilizer, a viscosity-modifying agent, and combinations thereof.

16. The method of claim 11, wherein the analyte comprises at least one biomolecule analyte having at least a S—S or a S—H group.

17. The method of claim 16, wherein the at least one assisting agent comprises a reducing agent capable of converting the S—S group into S—H group and/or preventing the S—H group from being oxidized or being coupled to another S—H group.

18. The method of claim 16, wherein the at least one assisting agent further comprises an alkylation agent capable of converting the S—H group into a more stable S—R group.

19. The method of claim 16, wherein the at least one assisting agent reduces inter-molecular coupling of the analyte through S—S formation.

20. The method of claim 15, wherein the at least one assisting agent comprises a reducing agent that is selected from the group consisting of: dithiothreitol (DTT), dithioerythritol (DTE), tris (2-carboxyethyl) phosphine hydrochloride (TCEP), 2-mercaptoethanol, 2-mercaptoethylamine, thioglycolic acid, cysteine, guanidine, urea, or any salt or derivative thereof, and combinations thereof.

21. The method of claim 15, wherein the at least one assisting agent comprises an alkylation agent that is selected from the group consisting of: iodoacetamide, iodoacetic acid, acrylamide, chloroacetamide, and combinations thereof.

22. A system for analyzing a sample, the system comprising:
a first plate handler;
a second plate handler;
a liquid handler;
an acoustic droplet ejector (ADE);
a processor operatively coupled to each of the first plate handler, the second plate handler, the liquid handler and the ADE, and memory, operatively connected to the processor, the memory storing instructions that, when executed by the processor, perform a set of operations comprising:
receiving, by the first plate handler, a well plate comprising a plurality of sample wells, each sample well configured to contain a sample having a sample volume;
introducing, by the liquid handler, at least one assisting agent into at least one sample well;
positioning via the second plate handler, an opposed sample well in relation to the at least one sample well;
ejecting, with the ADE, a mixture comprising the sample and the at least one assisting agent from the at least one sample well and into the opposed sample well.
